(19) United States
(12) Patent Application Publication
(10) Pub. No.: US 2009/0210608 A1
(43) Pub. Date: Aug. 20, 2009

(54) KVM switch and operation method thereof

(76) Inventors: Chi-Tung Chang, Nei Hu (TW); Jia-Lung Wang, Nei Hu (TW); Shih-Min Lan, Nei Hu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/155,686

(22) Filed: Jun. 9, 2008

(30) Foreign Application Priority Data
Feb. 15, 2008 (TW) 97105340

(51) Int. Cl. G06F 13/00

(52) U.S. Cl. 710/316

(57) ABSTRACT

A KVM switch and an operation method thereof can share at least one USB device to a plurality of computers, and the computers can directly communicate with the USB device through a switch module. The KVM switch further comprises a microprocessor and a USB controller. When switching in the KVM switch, by using the set information command in USB specification, the microprocessor can control the USB controller to interfere in setting the USB device to become receiving a signal sent by the computer which recognition data is representative. Then, the computers need not execute the enumeration process to recognize the USB device in every switching time. Hence, the KVM switch can improve the compatibility problem and increase switching efficiency.

### BACKGROUND OF THE INVENTION

1. Field of the invention

The present invention relates to a keyboard-video-mouse (KVM) switch, and more particularly to a KVM switch and a method of operating the KVM switch that provide the compatibility and improving the efficiency of the switch.

2. Description of Related Art

As science and technology advance rapidly, the use of computers becomes increasingly popular. If a user owns several computers and wants to share a same set of devices and display for the operation, the user will need a keyboard-video-mouse switch to switch the control, so that the computers do not each need to be connected to a peripheral (or console device) so that space can be saved.

As USB peripherals become more popular, the demand for external USB peripherals also becomes higher. At present, there are more and more KVM switch designs to go with a USB circuit in the local end, such that the KVM switch can provide the functions of sharing the USB peripherals, connecting the USB peripherals directly to the KVM switch, and sharing the USB peripherals by each computer, in addition to the function of switching the traditional PS/2 keyboard, mouse and screen.

The present KVM switch is mainly divided into two types, respectively: a mechanical design and an electronic design, and the mechanical design is based on a switching concept to achieve the switch by using an actual switch and operating the switch by a hardware switch circuit. For example, a mechanical KVM switch is generally used in several computers as an operating platform for switching the use of peripherals such as PS/2 keyboards and mice.

As specified in the USB specification, if a USB peripheral is connected to a computer host system, the computer host system will perform an enumeration process to identify a connected USB device, and the USB peripheral will report a device class of the identification, and obtain different transmission modes according to the different device classes. Therefore, the mechanical design designed with the concept of connecting external USB peripherals will have the following drawback. When a user operating at a computer host switches the operation to another computer host, the computer host has to identify the external USB peripherals again before use, and thus the switching procedure will take a longer time.

To overcome the drawback of the mechanical design, designers and manufacturers provide an electronic design which mainly adds a microprocessor for bridging all USB peripherals to the microprocessor, such that the USB peripherals can communicate with the computer host by the processing and switching of the microprocessor. The microprocessor is provided for receiving a switch signal produced when a user switches the computer host in order to switch to each computer host. Therefore, the microprocessor can identify the USB peripherals. After the user switches the use of a computer host, the microprocessor provides related information of the USB peripheral to the computer host, so that the computer host can be connected directly to the USB peripheral for its use without the need of identifying all USB peripherals again for each switch for the use.

Although the design of the electronic KVM switch can save the time of identifying the USB peripheral during a switching process, the electronic design uses the microprocessor to identify the USB peripherals, which is unlike the mechanical design of using the computer host (or operating system) for the identification. Therefore, the transmission and identification of USB signals performed by the microprocessor become key factors for testing the operation of the KVM switch, and the design of the microprocessors determines the compatibility of the KVM switch for various different USB peripherals, and it is necessary to update the microprocessor and introduce new USB peripherals frequently. As a result, the flexibility of the product application will become relatively low.

Therefore, finding an improved design for achieving better compatibility and enhancing the switching efficiency demand immediate attentions, extensive researches and feasible solutions.

### SUMMARY OF THE INVENTION

In view of the foregoing shortcomings of the prior art, it is a primary objective of the present invention to adopt a switching concept to go with a design of a microprocessor and a USB controller, such that a computer host can directly identify a USB peripheral without the need of performing an enumeration process for each time for switching and using the computer hosts. When the related KVM switches are switched, the KVM switch simply need to set up the USB peripherals to change the recognition data received from different computer hosts, so as to receive the data and signals transmitted only from the computer host represented by the recognition data. Therefore, the present invention can achieve a better compatibility and enhance the switching efficiency of the KVM switch concurrently.

To achieve the foregoing objectives, the present invention provides a KVM switch, for sharing at least one USB peripheral by a plurality of computer hosts, and the KVM switch comprises: a test unit, a switch module, a USB controller, a control unit and a microprocessor. The test unit is provided for obtaining connecting and operating statuses of the computer hosts to generate a detection signal. The switch module is coupled to the USB peripherals for transmitting signals between the USB peripherals and the computer hosts. The USB controller is coupled to the switch module for setting and controlling the USB peripherals. The control unit controls the switch module for performing a corresponding switch according to the detection signal, and outputting a switch information signal. The microprocessor records recognition data of each computer host, and controls the USB controller according to the switch information signal when the switch information signal is received in order to transmit a set information command corresponding to the recognition data to the USB peripheral. Therefore, the USB peripheral is switched directly for receiving a command signal issued by a computer host represented by recognition data corresponding to the set information command in order to improve the switching efficiency, and allow the computer host to identify the USB peripheral directly and provide a better compatibility.

To achieve the foregoing objectives, the present invention provides a method of operating a KVM switch for sharing at least one USB peripheral by a plurality of computer hosts. The method comprises the steps of: generating a switch information signal; transmitting a set information command to the USB peripheral according to the switch information signal to change the USB peripheral for receiving a command signal issued by a computer host corresponding to the set information command; and performing a switching procedure to switch the USB peripheral to be connected directly to the computer host specified by the switch information signal, such that after the switching procedure is executed, the USB peripheral can transmit signals directly with the switched computer host.

With the operation of the invention, after each computer host is switched and connected by the KVM switch, the computer host can be connected to the USB peripheral directly without going through the signal transfer, and the operating system of the computer host directly communicates and transmits signals to overcome the compatibility issue of the USB peripherals. When the KVM switch performs a switching process in accordance with the present invention, the USB peripheral is set to change the address of the receiving computer host, so that the computer hosts can be switched without the need of performing an enumeration to communicate with the USB peripherals directly and greatly enhance the switching efficiency of the KVM switch.

To make it easier for our examiner to understand the expected objectives, technical measures and effects of the present invention, we use preferred embodiments together with the attached drawings for the detailed description of the invention, but it should be pointed out that the attached drawings are provided for reference and description only, but not for limiting the present invention.

### BRIEF DESCRIPTION OF THE DRAWINGS

FIG. 1 is a schematic view of an application of a KVM switch in accordance with the present invention;

FIG. 2 is a block diagram of a KVM switch in accordance with a preferred embodiment of the present invention; and

FIG. 3 is a flow chart of a method of operating a KVM switch in accordance with a preferred embodiment of the present invention.

### DETAILED DESCRIPTION OF THE PREFERRED EMBODIMENTS

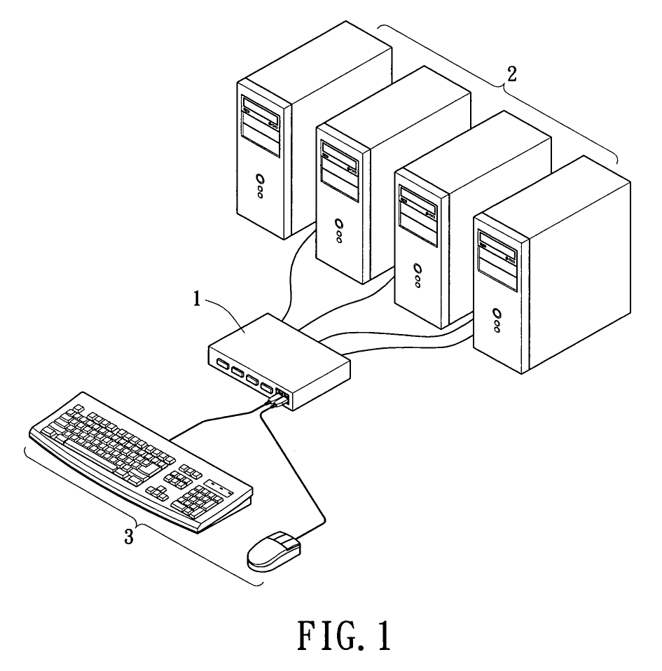

Referring to FIG. 1 for a schematic view of an application of a KVM switch in accordance with the present invention, the KVM switch 1 is used for sharing at least one USB peripheral 3 (such as a keyboard, a mouse and a storage device) by a plurality of computer hosts 2.

The KVM switch 1 of the invention adopts the concept of a hub and a switching concept for connecting a plurality of USB peripherals 3 directly after the computer host 2 is switched and connected, to overcome the compatibility issue of the KVM switch 1 to various different brands of USB peripherals 3. Further, a set information command used between devices according to the specification of a USB transmission protocol is adopted, and the set information commands includes commands such as Set Address and Set Configuration for changing the address and enumeration signals (different computer hosts 2 have their own specific address and enumeration signal) of the USB peripheral 3 when different computer hosts 2 are switched. Therefore, the computer host 2 does not need to go through the enumeration process to identify the USB peripheral 3 for each switching process, so as to greatly enhance the switching efficiency of the KVM switch 1.

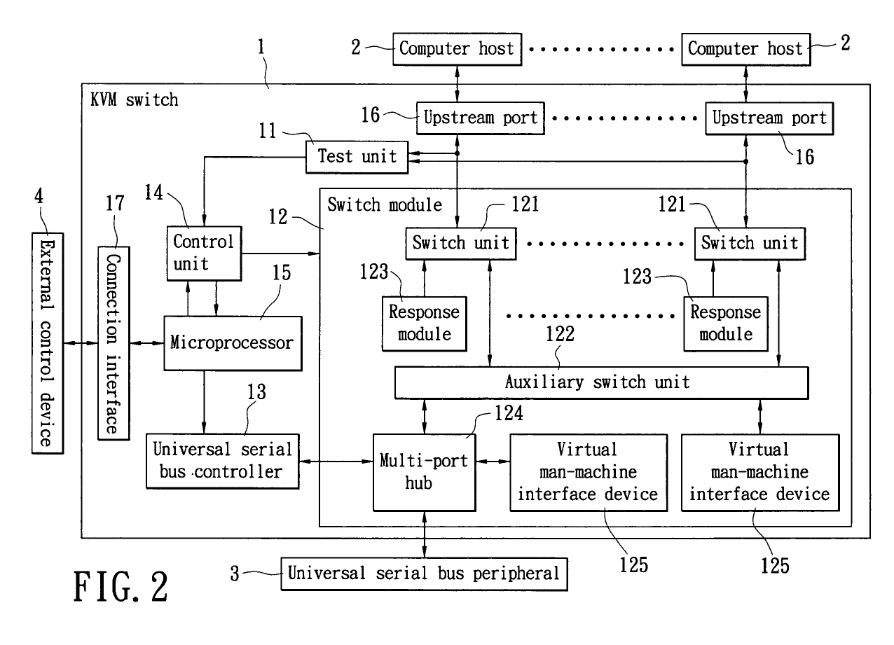

Referring to FIG. 2 for a block diagram of a KVM switch in accordance with a preferred embodiment of the present invention, this embodiment of the invention provides a KVM switch 1 for sharing USB peripherals 3 by computer hosts 2, and the KVM switch 1 comprises: a test unit 11, a switch module 12, a USB controller 13, a control unit 14, a microprocessor 15, a plurality of upstream ports 16 and a connection interface 17. The upstream port 16 is provided for connecting a corresponding computer host 2, and the number of upstream ports 16 is also the number of computer hosts 2 connectible to the KVM switch 1, and the number of upstream ports is not limited in this embodiment.

The test unit 11 is connected to the upstream ports 16 for detecting and obtaining connecting and operating statuses of the computer hosts 2. In other words, any computer host 2 connected to the KVM switch 1 is detected anytime. If a computer host 2 connected to any upstream port 16 is detected, then a detection signal will be generated, and the detection signal includes status information such as the operating status (ON, OFF, SLEEP, and WAKEUP, etc) of each computer host 2 and a status of which upstream port 16 is connected to each computer host 2.

The switch module 12 is provided for connecting the USB peripherals 3 and receiving a switch control of the control unit 14 to switch the USB peripheral 3 to a user's desired operating computer host 2 for transmitting signals between the USB peripherals 3 and the computer host 2. After the switch module 12 performs a switching process, the switch module 12 will reply to a command signal issued by the connected but currently not used computer host 2, such that each computer host 2 can be operated correctly. To achieve such switching effect, the switch module 12 further comprises: a plurality of switches 121, an auxiliary switch unit 122, a plurality of response modules 123, a multi-port hub 124 and a plurality of virtual man-machine interface devices 125.

The auxiliary switch unit 122 is connected to the virtual man-machine interface devices 125 and the multi-port hub 124. The multi-port hub 124 is provided for connecting the USB peripherals 3, and the virtual man-machine interface device 125 is provided for responding to the information required for performing a power-on self test (POST) of the basic input/output system (BIOS) of the computer host 2, when the computer host 2 is booted. Similarly, the number of virtual man-machine interface devices 125 in accordance with the design of the invention determines the number of upstream ports 16 of the KVM switch 1 for sufficiently supporting the connected computer hosts 2. One of the foregoing virtual man-machine interface devices 125 is connected to a multi-port hub 124, and the multi-port hub 124 is connected to the auxiliary switch unit 122, for responding required information to boot the computer host 2 if the multi-port hub 124 has not been connected to the USB peripheral 3, so as to boot the computer host 2 successfully.

The response module 123 is provided for generating a response signal such as a negative acknowledge (NAK) packet. In addition to being connected to the auxiliary switch unit 122 for receiving signals from devices assigned by the auxiliary switch unit 122, the switch units 121 further adopts a one-to-one correspondence method for connecting the response modules 123. If a currently used computer host 2 is switched to a non-operating status, the computer host 2 still can communicate with the response module 123, such that the non-operating computer host 2 is still considered to be not disconnected with the USB peripheral 3. In other words, the computer host 2 generally issues an inquiry command from time to time to request the connected USB peripheral 3 to respond. If the computer host 2 has been switched to a non-operating status, (or the USB peripherals 3 have been switched and assigned for other computer hosts 2), the connected switch unit 121 must be switched to connect the response module 123, so that when the computer host 2 issues an inquiry command, a related response signal such as a negative acknowledge (NAK) packet is received to conform the normal operations.

Thus, the control unit 14 will control the switch module 12 to perform a switching process according to the detection signal outputted by the test unit 11. The auxiliary switch unit 122 of the switch module 12 assigns the virtual man-machine interface device 125 and the USB peripheral 3 connected to the multi-port hub 124 to the switch units 121 according to a control of the control unit 14. The switch unit 121 of the switch module 12 switches the connection to each connected response module 123 or the auxiliary switch unit 122 according to a control of control unit 14 to respond to each computer host 2 through the upstream port 16.

In the default settings for the operation in accordance with this embodiment, after the control unit 14 receives the detection signal for controlling the switch module 12 to perform a corresponding switching process according to the boot information in the detection signal. For example, the USB peripheral 3 is switched and connected to the upstream port 16 that is connected to the first booted computer host 2. If another computer host 2 is booted, then the computer is switched and connected to the response module 123. If another computer host 2 is being booted, then the computer host 2 is switched and connected to the auxiliary switch unit 122 for receiving the assigned virtual man-machine interface device 125. The sequence of booting the computer hosts 2 is determined by the sequence of turning on the USB controllers in the local end (not shown in the figure) of the computer hosts 2.

The main technical characteristic of the invention resides on that when the KVM switch 1 switches to different computer hosts 2, the USB peripheral 3 is set up to change recognition data received by the computer host 2, so that the USB peripheral 3 can receive signals transmitted from the computer host 2 represented by the recognition data. In the invention, the USB controller 13 and the microprocessor 15 are designed and installed in the KVM switch 1. The USB controller 13 is connected to the switch module 12 for setting and controlling the USB peripheral 3. In actual designs, the USB controller 13 is connected directly to the USB peripheral 3 for achieving the control effect.

The microprocessor 15 is connected between the control unit 14 and the USB controller 13, and the microprocessor 15 records recognition data of each computer host 2, such that the microprocessor 15 controls the USB controller 13 according to a switch information signal outputted from the control unit 14 for controlling the switch module 12, so as to use a USB transmission protocol to transmit a set information command corresponding to the recognition data to the USB peripheral 3. Therefore, after the USB peripheral 3 receives the set information command, the USB peripheral 3 is changed directly for receiving a command signal issued by the computer host 2 represented by the corresponding recognition data. Therefore, when the KVM switch 1 switches different computer hosts 2, it is not necessary to perform an enumeration process, and the computer host 2 can switch to directly connect the USB peripheral 3 by the switch module 12 to perform signal transmission and communication.

It is noteworthy to point out that the condition for switching the computer hosts 2 in accordance with the embodiment can be achieved by inputting related string or press a key from the USB peripheral 3 (such as a keyboard) by a user to switch to a desired computer host 2 or directly operating an external control device 4 (such as a press key module, a processor or a related operating device) for an external control to achieve the switching effect, in addition to the aforementioned way of detecting the operating status of each computer host 2 first and switching to the first booted computer host 2.

Since the test unit 11 is connected to the upstream port 16, therefore when the USB peripheral 3 generates and transmits an input signal to the computer host 2, the design in accordance with this embodiment further obtains the input signal through the test unit 11 and provides the input signal to the control unit 14, such that when the control unit 14 determines whether or not the input signal matches a default port setting in the control unit 14, the port setting is used for controlling the switch module 12 to perform a corresponding switch and switch the connection of the USB peripheral 3 to the upstream port 16 corresponding to the port. Similarly, the switch information signal is outputted to the microprocessor 15 for setting up the USB peripheral 3 to change the recognition data possessed by the receiving computer host 2. For example, if the default port setting uses the signal of the “Ctrl+F1” key to map and represent a first upstream port, and the signal of the “Ctrl+F2” key to map and represent a second upstream port, and so on, then the input signals produced by pressing the “Ctrl” key and the “F1” key simultaneously by a user matches the default port setting, so as to switch the connection of the USB peripheral 3 to the first upstream port, and transmit signals to the computer host 2 connected to the first upstream port.

In the design of the external control device 4, the external control device 4is connected to the microprocessor 15 through a connection interface 17, wherein the connection interface 17 can be a serial or parallel transmission interface. Therefore, the microprocessor 15 of this embodiment is provided for receiving a port trigger signal generated by the external control device 4, for converting and outputting a switch signal to the control unit 14 to switch the control by the auxiliary control unit 14. Therefore, the control unit 14 controls can control switch module 12 according to the switch signal to switch the connection of the USB peripheral 3 to the upstream port 16 specified by the port trigger signal, and output the switch information signal to the microprocessor 15 to set up the USB peripheral 3 to change the recognition data possessed by the receiving computer host 2.

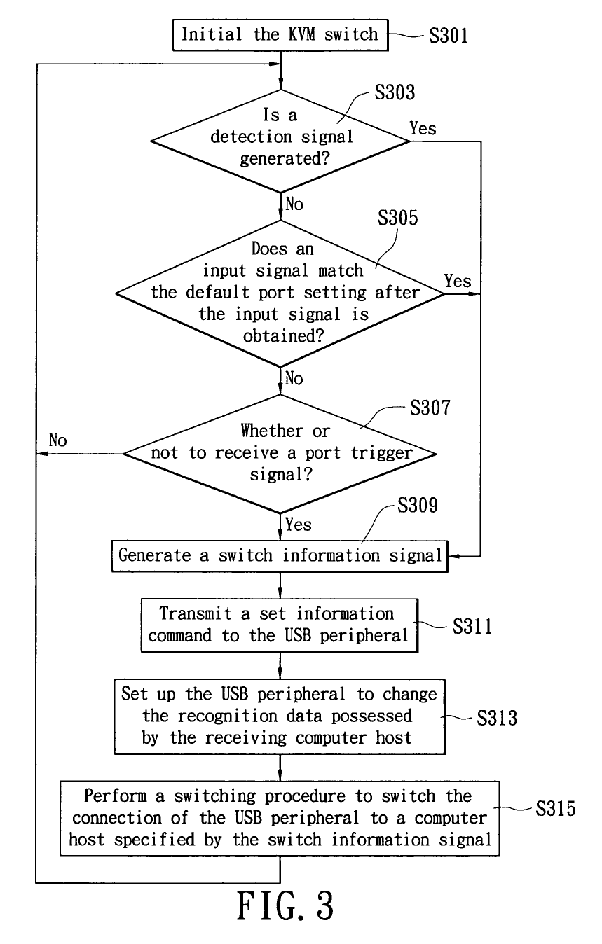

Referring to FIG. 3 a flow chart of a method of operating a KVM switch in accordance with a preferred embodiment of the present invention, the invention provides a method of operating a KVM switch 1 for sharing the USB peripherals 3 by a plurality of computer hosts 2, and the method comprises the following steps. Initial the KVM switch 1 after turning on the KVM switch 1 (S301), wherein a multi-port hub 124 is switched and connected to a first upstream port and a virtual man-machine interface device 125 is assigned to connect to the rest of the upstream ports during the initialization process.

Detect whether or not any computer host 2 is connected to the KVM switch 1, or detect connecting and operating statuses of the original connected computer host 2 to determine whether or not to generate a detection signal (S303). If the determination result is negative, it shows that no new computer host 2 is connected or the original connected computer host 2 is not at a power off or sleep mode, and thus the switching status of the KVM switch 1 can be maintained. In addition, during the operation of the KVM switch 1, the input signal generated and inputted by the computer host 2 for accessing the USB peripheral 3 is obtained to determine whether or not the input signal matches the default port setting (S305). If the determination result is negative, it indicates that the user has not pressed the related key or entered the related string for switching the computer host 2, so that the input signal does not match the port setting, and the KVM switch 1 still maintains the current switching status. Further, the KVM switch 1 determines whether or not a port trigger signal generated by the external control device 4 is received during the operation (S307). If the determination result is negative, it indicates that the user does not use the external control device 4 to control and switch different computer hosts 2, and thus the KVM switch 1 will maintain the current switching status. Repeat Step (S301) and continue the following steps of the procedure.

If the determination result of any one of the Steps (S303), (S305) and (S307) is affirmative, a switch information signal will be generated (S309) to indicate that the KVM switch 1 has to change the current switching status. If the determination result of Step (S301) is affirmative, a switch information signal will be generated according to the detection signal. If the determination result of Step (S305) is affirmative, a switch information signal will be generated according to the port setting. If the determination result of Step (S307) is affirmative, a switch information signal will be generated according to the port trigger signal.

After a switch information signal is generated in Step (S309), a set information command will be transmitted to the USB peripheral 3 according to the switch information signal (S311) to set up the USB peripheral 3 to change the recognition data possessed by the receiving computer host 2 (S313), which is to change the recognition data of the switched and connected computer host, so that the USB peripheral 3 will receive a command signal issued by the computer host 2 for receiving recognition data corresponding to the set information command.

After the setting is changed, a switching procedure is performed to switch the connection of the USB peripheral 3 to a computer host 2 specified by the switch information signal (S315). By repeating the foregoing steps, the computer host 2 can connect the USB peripheral 3 for transmitting data and signals directly without going through the enumeration process each time.

In summation of the description above, the microprocessor and the USB controller of the invention only performs the setup when the KVM switch switches different computer hosts, such that the operating system of the computer hosts can transmit signals and communicate with the USB peripherals directly by switching between the computer hosts and the USB peripherals without the need of bridging the microprocessor and the USB controller, so as to overcome the compatibility issue of the USB peripherals. During a switching process in accordance with the invention, the USB peripherals are set to change the address of the computer host, so that the switched computer host no longer needs an enumeration to communicate with the USB peripherals, so as to greatly enhance the switching efficiency of the KVM switch.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A KVM switch, for sharing at least one USB peripheral by a plurality of computer hosts, the KVM switch comprising:
a test unit, for detecting connecting and operating statuses of the computer hosts to generate a detection signal;
a switch module, coupled to the USB peripheral, for transmitting a signal between the USB peripheral and the computer hosts;
a USB controller, coupled to the switch module, for setting and controlling the USB peripheral;
a control unit, for controlling a corresponding switch of the switch module according to the detection signal, and outputting a switch information signal; and
a microprocessor, for recording recognition data of each computer host, and controlling the USB controller according to the switch information signal to transmit a set information command corresponding to the recognition data to the USB peripheral;
thereby, the USB peripheral directly changes to receive a command signal issued by the computer host represented toward the recognition data corresponding to the set information command.

2. The KVM switch of claim 1, further comprising a plurality of upstream ports, for connecting the corresponding computer hosts.

3. The KVM switch of claim 2, wherein the control unit controls the switch module according to the detection signal to switch the USB peripheral to the upstream port connected to the first booted computer host.

4. The KVM switch of claim 2, wherein the test unit is provided for obtaining an input signal inputted from the USB peripheral to the computer hosts.

5. The KVM switch of claim 4, wherein the control unit further determines whether or not the input signal matches a predetermined port setting, and controls the switch module to switch and connect the USB peripheral to the upstream port corresponding to the port setting.

6. The KVM switch of claim 2, further comprising a connection interface, coupled to the microprocessor, for receiving a port trigger signal generated by an external control device, and the microprocessor further generates a switch signal to the control unit.

7. The KVM switch of claim 6, wherein the control unit further controls the switch module according to the switch signal to switch and connect the USB peripheral to the upstream port specified by the port trigger signal.

8. The KVM switch of claim 6, wherein the connection interface is a serial or parallel interface.

9. The KVM switch of claim 1, wherein the switch module further comprises:
a plurality of virtual man-machine interface devices;
a plurality of response modules, for generating a response signal;
a multi-port hub, for connecting the USB peripheral;
a plurality of switches, for connecting the response modules and the upstream ports in a one-to-one correspondence; and
an auxiliary switch unit, coupled to the virtual man-machine interface devices and the multi-port hub, for assigning the virtual man-machine interface devices and the USB peripheral to the switch units according to the control of the control unit;
thereby, the switch units are switched and connected to the connected response module or the auxiliary switch unit according to a control of the control unit to respond to a command signal issued by the computer hosts through the upstream ports respectively.

10. The KVM switch of claim 9, wherein one of the virtual man-machine interface devices is coupled to the multi-port hub for connecting the auxiliary switch unit through the multi-port hub.

11. The KVM switch of claim 9, wherein the USB controller is coupled to the multi-port hub for controlling the USB peripheral.

12. The KVM switch of claim 1, wherein the set information command includes commands of Set Address and Set Configuration.

13. A method of operating a KVM switch, for sharing at least one USB peripheral by a plurality of computer hosts, and the method comprising the steps of:
confirming to generate a switch information signal;
transmitting a set information command to the USB peripheral according to the switch information signal, to change the USB peripheral for receiving a command signal issued by a computer host corresponding to the set information command; and
performing a switching procedure to switch a connection of the USB peripheral to the computer host specified by the switch information signal;
thereby, after the switching procedure, the USB peripheral can transmit a signal directly to the switched computer host.

14. The method of operating a KVM switch of claim 13, further comprising the steps of:
determining connecting and operating statuses of the computer hosts to generate a detection signal; and
generating the switch information signal according to the detection signal.

15. The method of operating a KVM switch of claim 13, further comprising the steps of:
obtaining an input signal inputted from the USB peripheral to the computer hosts; and
determining whether or not the input signal matches a predetermined port setting to generate the switch information signal.

16. The method of operating a KVM switch of claim 13, further comprising the step of:
receiving a port trigger signal, for generating the switch information signal according to the port trigger signal.

17. The method of operating a KVM switch of claim 16, wherein the port trigger signal is generated by an external control device.

18. The method of operating a KVM switch of claim 13, wherein the set information command includes commands of Set Address and Set Configuration.
